(19) United States
(12) Patent Application Publication
(10) Pub. No.: US 2014/0009504 A1
(43) Pub. Date: Jan. 9, 2014

(54) HANDHELD DEVICE AND METHOD FOR DISPLAYING SOFTWARE INTERFACE

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 13/726,010

(22) Filed: Dec. 22, 2012

(30) Foreign Application Priority Data
Jul. 9, 2012 (TW) 101124571

(51) Int. Cl. G06T 3/20

(52) U.S. Cl. CPC G06T 3/20
USPC 345/682

(57) ABSTRACT

In a method for displaying a software interface on a display screen of a handheld device, initial software icons corresponding to an initial state of the handheld device are first displayed on the display screen. The method detects a current state of the handheld device, and determines movement information of the handheld device between the current state and the initial state of the handheld device. The method further determines current software icons on the display screen according to the movement information of the handheld device, and displays the current software icons on the display screen.

### BACKGROUND

1. Technical Field

Embodiments of the present disclosure relate to data displaying technology, and particularly to a handheld device and method for displaying a software interface on a display screen of the handheld device.

2. Description of Related Art

Touch panels are widely used in handheld devices (e.g., smart phones), it is convenient for a user as many touch panels support finger slide operation. For example, when the user slides a finger on the touch panel in a left direction, software icons of a software interface displayed on the touch panel will move left in response to receiving the left slide operation. However, frequent slide operations on the touch panel may influence the quality (e.g., sensitivity) of touch panel. Therefore, an efficient method for displaying a software interface on a display screen of a handheld device is desired.

### BRIEF DESCRIPTION OF THE DRAWINGS

FIG. 1 is a schematic diagram of one embodiment of a handheld device including a software interface display system.

FIG. 2 is a schematic diagram of function modules of the software interface display system included in the handheld device.

FIG. 3 is a flowchart of one embodiment of a method for displaying a software interface on a physical display screen of the handheld device.

FIG. 4 is a schematic diagram of an example of a virtual display screen in a first embodiment.

FIG. 5 is a schematic diagram of an example of setting initial software icons on the physical display screen corresponding to an initial state of the handheld device in the first embodiment.

FIG. 6 is a schematic diagram of an example of a virtual display area in the virtual display screen.

FIG. 7 is a schematic diagram of an example of the virtual display screen in a second embodiment.

FIG. 8 is a schematic diagram of an example of the virtual display screen in a third embodiment.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

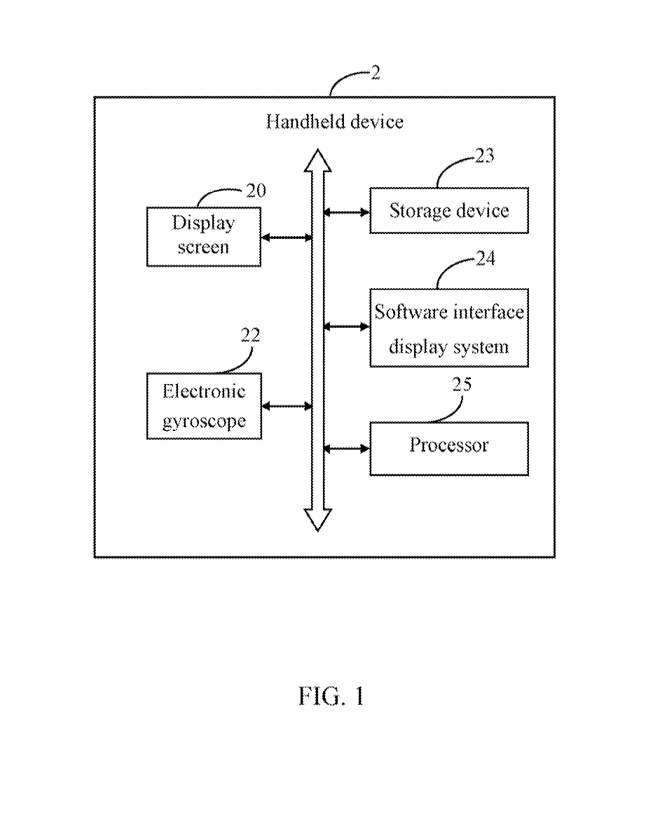

FIG. 1 is a block diagram of one embodiment of a handheld device 2. The hand held device 2 includes a software interface display system 24. The handheld device 2 further includes a display screen 20 (hereinafter refers to as “physical display screen”), an electronic gyroscope 22, a storage device 23, and at least one processor 25. It should be understood that FIG. 1 illustrates only one example of the handheld device 2 that may include more or fewer components than illustrated, or a different configuration of the various components in other embodiments. The physical display screen 20 may be a touch panel, such as a capacitive multi touch panel.

In one embodiment, the handheld device 2 may be a smart phone. The electronic gyroscope 22 is used to detect a state (e.g., a direction and an angle) of the handheld device 2 at a preset time interval (e.g., five seconds). For example, the electronic gyroscope 22 may be a two-axis gyro or a three-axis gyro.

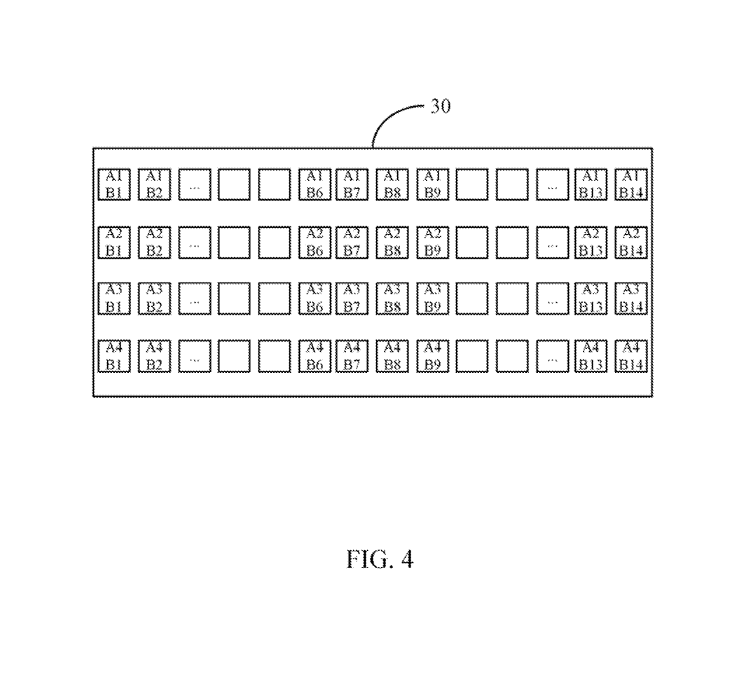

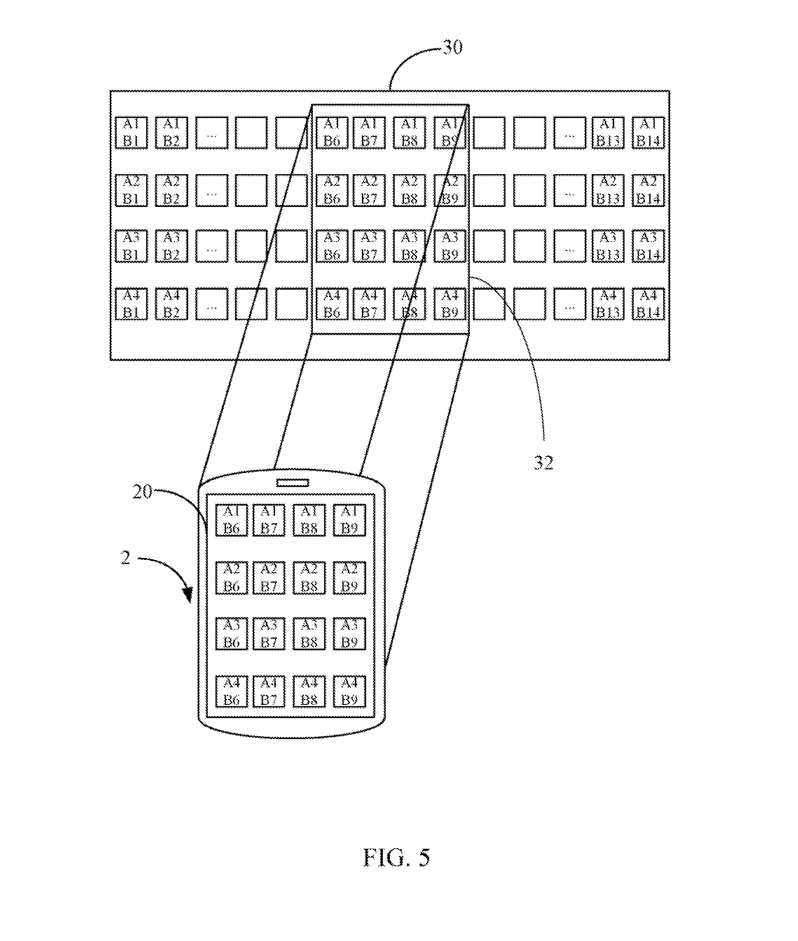

In one embodiment, the storage device 23 may be a smart media card, a secure digital card, a compact flash card, or any other memory storage device. The storage device 23 stores a preset virtual display screen 30. FIG. 4 shows that the virtual display screen 30 includes a plurality of software icons (e.g., icon “A1B1”). In a first embodiment, the virtual display screen 30 includes a 4×14 array (4 rows, 14 ranks) of software icons. Each software icon represent an application program (e.g., Calendar), the application program is activated when the corresponding software icon is selected. Because a size of the physical display screen 20 is limited, all of the software icons of the virtual display screen 30 cannot be displayed on the physical display screen 20 at one time. In one embodiment, as shown in FIG. 5, the software icons within a virtual display area 32 of the virtual display screen 30 are displayed on the physical display screen 20 of the handheld device 2.

The software interface display system 24 is used to update the software icons (software interface) displayed on the physical display screen 20 according to movements of the handheld device 2. In one embodiment, the software interface display system 24 may include computerized instructions in the form of one or more programs that are executed by the processor 25 and stored in the storage device 23 (or memory). A detailed description of the software interface display system 24 will be given in the following paragraphs.

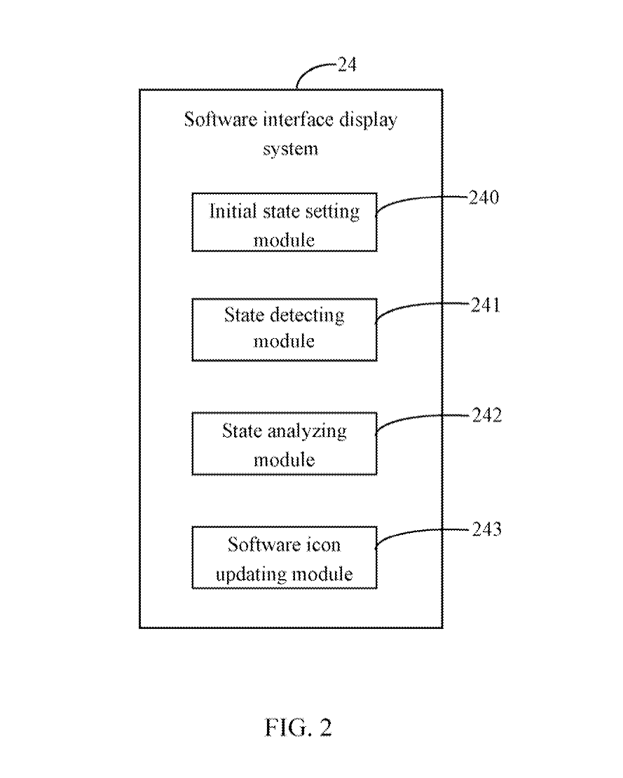

FIG. 2 is a block diagram of function modules of the software interface display system 24 included in the handheld device 2. In one embodiment, the software interface display system 24 may include one or more modules, for example, an initial state setting module 240, a state detecting module 241, a state analyzing module 242, and a software icon updating module 243. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

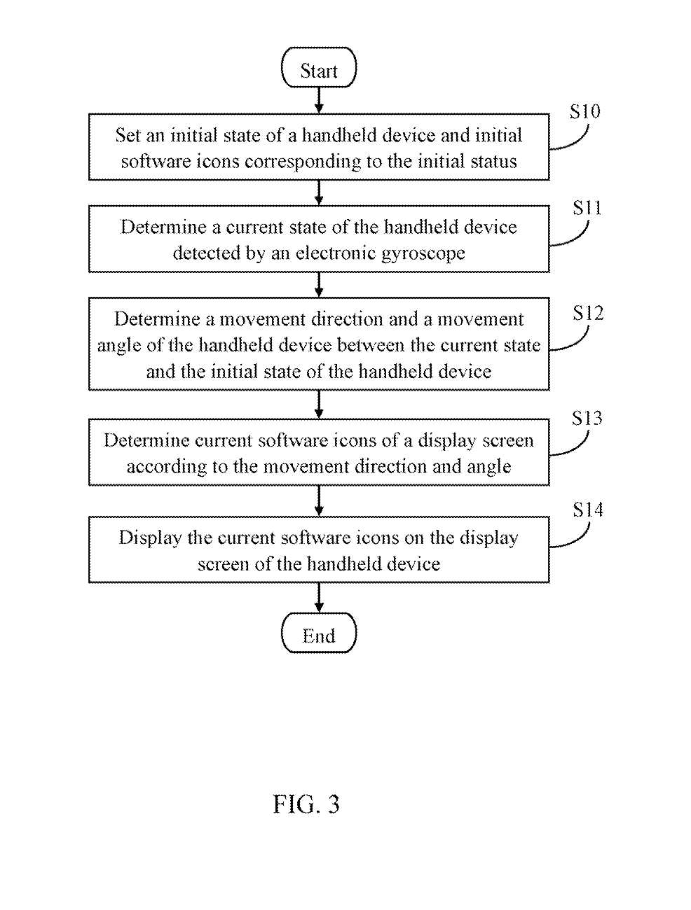

FIG. 3 is a flowchart of one embodiment of a method for displaying a software interface on the physical display screen 20 of the handheld device 2. Depending on the embodiment, additional steps may be added, others removed, and the ordering of the steps may be changed.

In block S10, the initial state setting module 240 sets an initial state of the handheld device 2 and initial software icons corresponding to the initial state, and displays the initial software icons on the physical display screen 20. The initial state setting module 240 stores an initial angle and an initial direction of the handheld device 2 into the storage device 23 or the memory. In one embodiment, the initial state may correspond to the initial angle and the initial direction or other kinds of parameters of the handheld device 2 which are detected by the electronic gyroscope 22. The initial software icons are specified icons within the virtual display area 32 when the virtual display area 32 is located at an initial position (e.g., a center) of the virtual display screen 30, where a virtual size of the virtual display area 32 is equal to an actual size of the physical display screen 20.

For example, as shown in FIG. 5, the virtual size of the virtual display area 32 is determined as 4×4 icon array, and the actual size of the physical display screen 20 is also determined as 4×4 icon array. Then, the initial software icons within the virtual display area 32 are determined to be “A1B6, A1B7, A1B8, A1B9, A2B6, A2B7, A2B8, A2B9, A3B6, A3B7, A3B8, A3B9, A4B6, A4B7, A4B8, A4B9”, where the software icons within the virtual display area 32 are determined to be initial icons need to be displayed on the physical display screen 20. In one embodiment, a position of the virtual display area 32 is moveable when the handheld device 2 is moved so that the software icons displayed on the physical display screen 20 are changed in response to the movements of the handheld device 2.

In block S11, the state detecting module 241 determines a current state of the handheld device 2 detected by the electronic gyroscope 22 at each preset time interval. In one embodiment, the current state of the handheld device 2 may correspond to, a current angle and a current direction of the handheld device 2 which are detected by the electronic gyroscope 22. In other embodiments, the initial state or the current state of the handheld device 2 may be detected by other electronic components, such as an electronic compass.

In block S12, the state analyzing module 242 determines a movement direction and a movement angle of the handheld device 2 between the current state and the initial state of the handheld device 2. For example, the state analyzing module 242 determines the movement direction and the movement angle related with the initial state of the handheld device 2 by comparing the initial angle and the initial direction with the current angle and the current direction of the handheld device 2 correspondingly.

In block S13, the software icon updating module 243 determines current software icons of the physical display screen 20 according to the movement direction and the movement angle of the handheld device 2.

The software icon updating module 243 determines a movement step length of the virtual display area 32 according to the movement angle of the handheld device 2. For example, the virtual display area 32 moves one step length when the movement angle of the handheld device 2 is added six degrees. The virtual display area 32 stops moving when the movement angle of the handheld device 2 reaches a preset maximum angle (e.g., 30 degrees).

The software icon updating module 243 moves the virtual display area 32 from the initial position to a current position on the virtual display screen 30 according to the determined movement step length, and determines the current software icons within the virtual display area 32 at the current position.

In block S14, the software icon updating module 243 displays the current software icons on the physical display screen 20 of the handheld device 2.

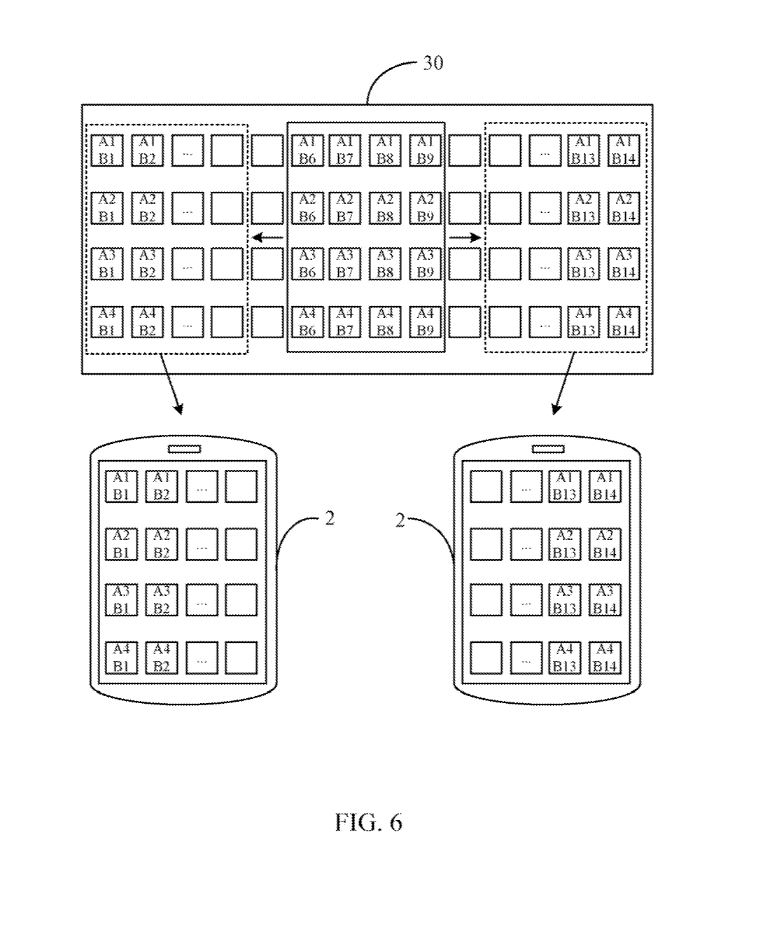

For example, as shown in FIG. 6, suppose that the handheld device 2 is rotated left, the virtual display screen 30 includes an array of software icons of 4×14 , the actual size of the physical display screen 20 is an array of software icons of 4×4. The virtual display area 32 reaches a border position (i.e., broken line) of the virtual display screen 30 when the virtual display area 32 moves five step lengths towards left (or right). If the preset maximum angle is 30 degrees, the handheld device 2 needs to rotate six degrees (30/5=6) towards left (or right) to move the virtual display area 32 one step length towards left (or right).

If the movement direction of the handheld 2 is left, represents the movement angle of the handheld device 2.

If −6 degrees<α<0, the software icon updating module 243 determines that the handheld device 2 is not moved (ignores the movement of the handheld device 2), and the virtual display area 32 is still located on the initial position (in the center of the virtual display screen 30).

If −12 degrees<α≦−6 degrees, the software icon updating module 243 moves the virtual display area 32 one step length toward left from the initial position.

If −18 degrees<α≦−12 degrees, the software icon updating module 243 moves the virtual display area 32 two step lengths toward left from the initial position.

If −24 degrees<α≦−18 degrees, the software icon updating module 243 moves the virtual display area 32 three step lengths toward left from the initial position.

If −30 degrees<α≦−24 degrees, the software icon updating module 243 moves the virtual display area 32 four step lengths toward left from the initial position.

If α≦−30 degrees, the software icon updating module 243 moves the virtual display area 32 five step lengths toward left from the initial position.

If the movement direction of the handheld 2 is right, “α” represents the movement angle of the handheld device 2.

If 0<α<6 degrees, the software icon updating module 243 determines that the handheld device 2 is not moved (ignores the movement of the handheld device 2), and the virtual display area 32 is still located on the initial position (in the center of the virtual display screen 30).

If 6 degrees<α<12 degrees, the software icon updating module 243 moves the virtual display area 32 one step length toward right from the initial position.

If 12 degrees<α<18 degrees, the software icon updating module 243 moves the virtual display area 32 two step lengths toward right from the initial position.

If 18 degrees<α<24 degrees, the software icon updating module 243 moves the virtual display area 32 three step lengths toward right from the initial position.

If 24 degrees<α<30 degrees, the software icon updating module 243 moves the virtual display area 32 four step lengths toward right from the initial position.

If 30 degrees<α, the software icon updating module 243 moves the virtual display area 32 five step lengths toward right from the initial position.

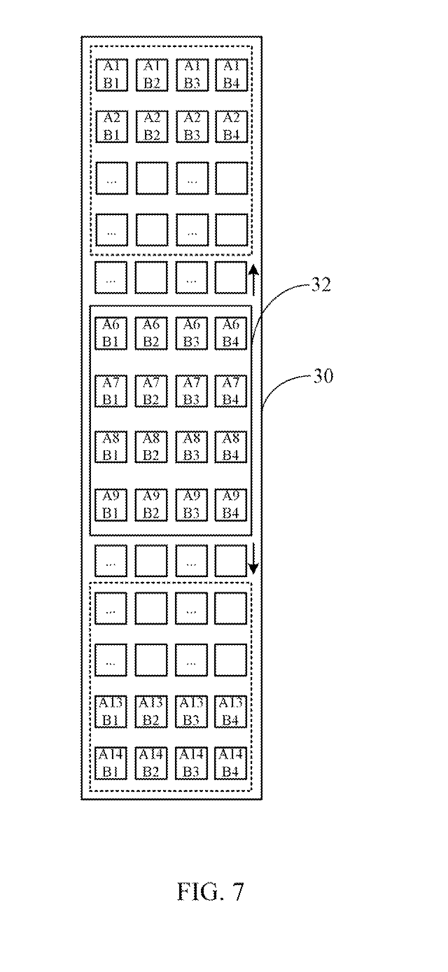

FIG. 7 is a schematic diagram of an example of the virtual display screen 30 in a second embodiment. As shown in FIG. 7, the virtual display screen 30 includes an array of software icons of 14×4 (14 rows, 4 ranks). The virtual display area 32 reaches the border position (i.e., broken line) of the virtual display screen 30 when the virtual display area 32 moves five step lengths towards up (or down). If the preset maximum angle is 30 degrees, the handheld device 2 needs to rotate six degrees (30/5=6) towards up (or down) to move the virtual display area 32 one step length towards up (or down).

A movement of the virtual display area 32 in the second embodiment is similar to the first embodiment.

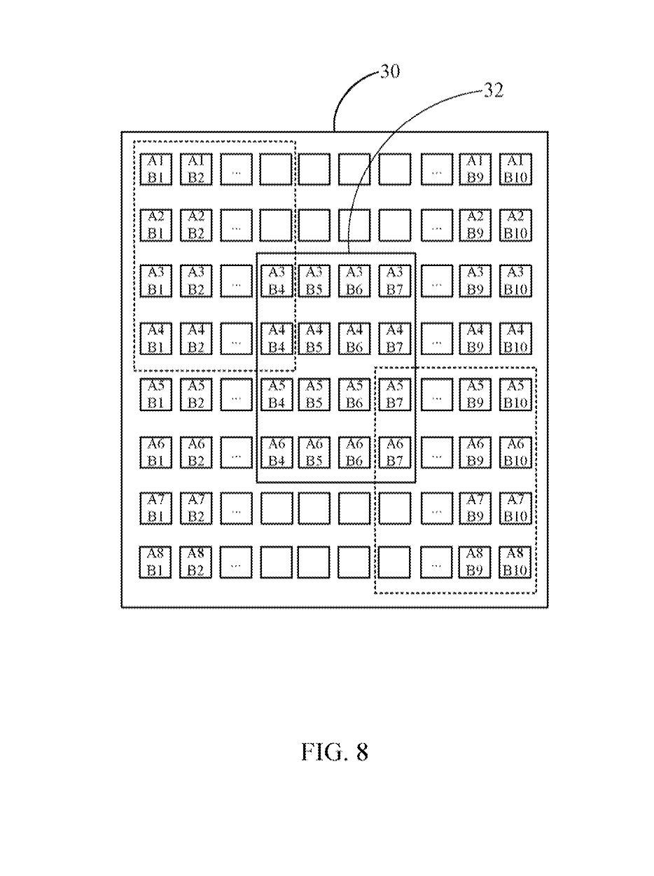

In other embodiments, the virtual display area 32 may move upper left, bottom left, upper right, and bottom right. For example, as shown in FIG. 8, the virtual display screen 30 includes an array of software icons of 8×10 (8 rows, 10 ranks). The virtual display area 32 may be moved toward upper left from the initial position (the center of the virtual display screen 30).

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for displaying a software interface on a physical display screen of a handheld device, the method comprising:
displaying initial software icons corresponding to an initial state of the handheld device on the physical display screen;
detecting a current state of the handheld device;
determining movement information of the handheld device by comparing the current state and the initial state of the handheld device;
determining current software icons on the physical display screen according to the movement information of the handheld device; and
displaying the current software icons on the physical display screen of the handheld device.

2. The method according to claim 1, wherein the movement information comprises a movement direction and a movement angle of the handheld device.

3. The method according to claim 2, wherein the initial software icons are specified icons within a virtual display area of a virtual display screen when the virtual display area is located at an initial position of the virtual display screen, a virtual size of the virtual display area being equal to an actual size of the physical display screen.

4. The method according to claim 3, wherein the initial state of the handheld device corresponds to an initial angle and an initial direction of the handheld device, and the current state of the handheld device corresponds to a current angle and a current direction of the handheld device.

5. The method according to claim 3, wherein the current software icons on the physical display screen are determined by:
determining a movement step length of the virtual display area according to the movement angle of the handheld device; and
moving the virtual display area from the initial position to a current position on the virtual display screen according to the determined movement step length, and determining the current software icons within the virtual display area at the current position.

6. The method according to claim 5, wherein the virtual display area stops moving upon the condition that the movement angle of the handheld device reaches a preset maximum angle.

7. A handheld device, comprising:
a storage device;
at least one processor; and
one or more modules that are stored in the storage device and are executed by the at least one processor, the one or more modules comprising:
an initial state setting module that displays initial software icons corresponding to an initial state of the handheld device on a physical display screen of the handheld device;
a state detecting module that detects a current state of the handheld device;
a state analyzing module that determines movement information of the handheld device by comparing the current state and the initial state of the handheld device;
a software icon updating module that determines current software icons on the physical display screen according to the movement information of the handheld device; and
the software icon updating module further displays the current software icons on the physical display screen of the handheld device.

8. The handheld device according to claim 7, wherein the movement information comprises a movement direction and a movement angle of the handheld device.

9. The handheld device according to claim 8, wherein the initial software icons are specified icons within a virtual display area of a virtual display screen when the virtual display area is located at an initial position of the virtual display screen, a virtual size of the virtual display area being equal to an actual size of the physical display screen.

10. The handheld device according to claim 9, wherein the initial state of the handheld device corresponds to an initial angle and an initial direction of the handheld device, and the current state of the handheld device corresponds to a current angle and a current direction of the handheld device.

11. The handheld device according to claim 9, wherein the software icon updating module determines the current software icons on the physical display screen by:
determining a movement step length of the virtual display area according to the movement angle of the handheld device; and
moving the virtual display area from the initial position to a current position on the virtual display screen according to the determined movement step length, and determining the current software icons within the virtual display area at the current position.

12. The handheld device according to claim 11, wherein the virtual display area stops moving upon the condition that the movement angle of the handheld device reaches a preset maximum angle.

13. A non-transitory storage medium having stored thereon instructions that, when executed by a processor of a handheld device, causes the handheld device to perform a method for displaying a software interface on a physical display screen of the handheld device, the method comprising:
displaying initial software icons corresponding to an initial state of the handheld device on the physical display screen;
detecting a current state of the handheld device;
determining movement information of the handheld device by comparing the current state and the initial state of the handheld device;
determining current software icons on the physical display screen according to the movement information of the handheld device; and
displaying the current software icons on the physical display screen of the handheld device.

14. The non-transitory storage medium according to claim 13, wherein the movement information comprises a movement direction and a movement angle of the handheld device.

15. The non-transitory storage medium according to claim 14, wherein the initial software icons are specified icons within a virtual display area of a virtual display screen when the virtual display area is located at an initial position of the virtual display screen, a virtual size of the virtual display area being equal to an actual size of the physical display screen.

16. The non-transitory storage medium according to claim 15, wherein the initial state of the handheld device corresponds to an initial angle and an initial direction of the handheld device, and the current state of the handheld device corresponds to a current angle and a current direction of the handheld device.

17. The non-transitory storage medium according to claim 15, wherein the current software icons on the physical display screen are determined by:
determining a movement step length of the virtual display area according to the movement angle of the handheld device; and
moving the virtual display area from the initial position to a current position on the virtual display screen according to the determined movement step length, and determining the current software icons within the virtual display area at the current position.

18. The non-transitory storage medium according to claim 17, wherein the virtual display area stops moving upon the condition that the movement angle of the handheld device reaches a preset maximum angle.
